(19) United States
(12) Patent Application Publication
(10) Pub. No.: US 2008/0037418 A1
(43) Pub. Date: Feb. 14, 2008

(54) Method, system, apparatus, and program to link aggregate over independent redundant switches

(75) Inventors: Mark W. Cole, Santa Rosa, CA (US); Richard S. Lopez, San Anselmo, CA (US); Corry A. Cordes, Cotati, CA (US); Brent A. Leever, Santa Rosa, CA (US)

Correspondence Address: FITZPATRICK CELLA HARPER & SCINTO, 30 ROCKEFELLER PLAZA, NEW YORK, NY, 10112, US

(73) Assignee: TELLABS PETALUMA, INC., Naperville, IL (US)

(21) Appl. No.: 11/502,825

(22) Filed: Aug. 10, 2006

(51) Int. Cl. H04J 3/14

(52) U.S. Cl. 370/220; 370/401

(57) ABSTRACT

A method to link aggregate over independent redundant switches is provided for use in an apparatus including first, second, and third switches in a local area network (LAN). A first port of the first switch is connected to a first port of the second switch, a second port of the second switch is connected to a first port of the third switch, and a second port of the third switch is connected to a second port of the first switch. The method includes forming a first link aggregation group (LAG) between the first and second ports of the first switch; forming a second LAG between the first and second ports of the second switch; and applying a port forwarding rule to the first and second ports of the second switch, where the first switch is in an active mode and the second switch is in a standby mode.

### BACKGROUND OF THE INVENTION

1. Field of the Invention

This invention relates to link aggregation over independent redundant switches, and, in particular, to methods, systems, apparatus, and programs for solving link aggregation across separate switch/bridge entities for the purposes including load sharing and resiliency.

2. Related Art

Ethernet is a very common local area network (LAN) switching technology defined in the IEEE 802.3 Standard. Ethernet is a shared medium where all devices on the Ethernet can communicate point-to-point linked in a star-like fashion. As shown in FIG. 1, Ethernet switches 11, 12, and 13 are all point-to-point connected, via respective links connected to respective ports, to an Ethernet switch 14.

Ethernet switches operate at the Open System Interconnection (OSI) data link layer (layer 2) and communicate with each other using data packets.

Link aggregation, or IEEE 802.3ad, is a computer networking term used to describe the bonding together of two or more data channels into a single channel that appears as a single, higher-bandwidth logical link. Other terms for link aggregation are Link Aggregation Group (LAG) and “port trunking.”

Aggregated links can also provide redundancy and fault tolerance when each of the aggregated links follows a different physical path. The fault tolerance or resiliency can be provided because when a link in a LAG fails, traffic can be automatically re-routed to the other link.

A typical Ethernet LAG enables separate physical Ethernet ports of an Ethernet switch, for example, to be bundled together and appearing as a single port. The LAG is formed at the OSI layer 2 and can increase the bandwidth of an Ethernet interface and provide resiliency. In a redundant switch configuration this is especially useful.

A redundant switch configuration is a setup where there are at least two Ethernet switches (hereinafter referred as “switches”) are set up: one in an active mode and another in a standby mode (also referred to as “backup mode”). Failure of the switch in the active mode requires a switch to the switch in the backup mode. In some cases, a link to these switches fails and a LAG protocol forwards traffic to the links that are still available depending on the system configuration. The same occurs when the link fails and the switch remains healthy; in this case, traffic is forwarded by way of the healthy links.

FIG. 2 shows an example of the benefits of forming a LAG. In FIG. 2, the ports of switch 11 have been entered into a LAG and are connected with the ports of switch 14. By adding a second link, as shown, the bandwidth is doubled.

Further, in the case where one of the links fails, the other link can be used. In this case the bandwidth is reduced to the maximum capacity of the remaining single link.

A problem with previously proposed methods has been the difficulty of installing LAG over different switches because of the lack of hardware assistance and/or interoperability.

There is a need, therefore, to provide improved methods, systems, apparatus, and programs to link aggregate across different switches while optimizing the bandwidth and resiliency of the network. This would be particularly helpful in cases where two switches are a redundant pair.

### SUMMARY OF THE INVENTION

The foregoing and other problems are overcome by methods, programs, apparatus, and systems to link aggregate over independent redundant switches using forwarding rules.

In accordance with an exemplary embodiment of the invention a method is provided for use in an apparatus including first, second, and third switches in a local area network (LAN). A first port of the first switch is connected to a first port of the second switch, a second port of the second switch is connected to a first port of the third switch, and a second port of the third switch is connected to a second port of the first switch. The method includes forming a first link aggregation group (LAG) between the first and second ports of the first switch; forming a second LAG between the first and second ports of the second switch; and applying a port forwarding rule to the first and second ports of the second switch, when the first switch is in an active mode and the second switch is in a standby mode.

The invention enables LAG groups to be set up over different redundant switches, even when provided by different vendors, without additional hardware and/or interoperability issues.

### BRIEF DESCRIPTION OF THE DRAWINGS

The present invention will be more readily understood from a detailed description of exemplary embodiments of the invention taken in conjunction with the following figures:

FIG. 1 illustrates a conventional point-to-point Ethernet connection.

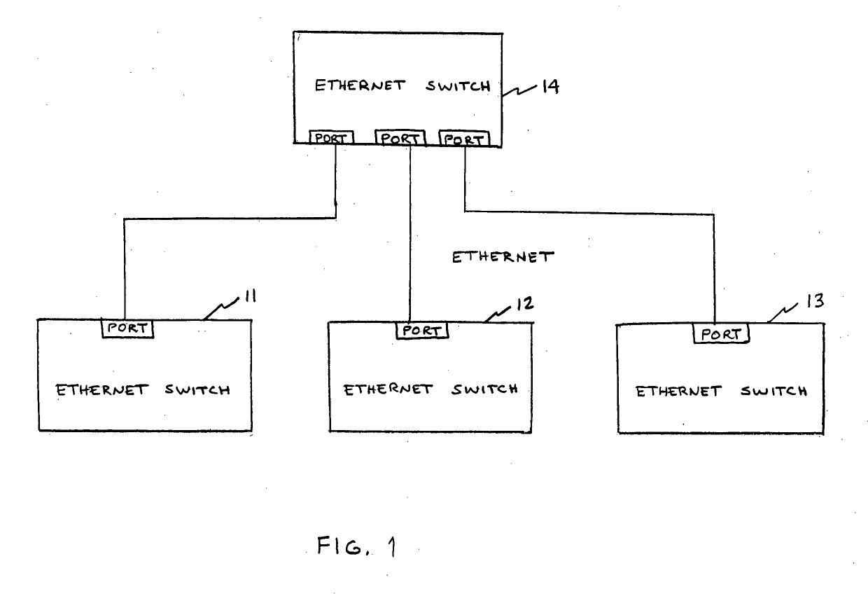

FIG. 2 illustrates a conventional point-to-point Ethernet connection including a LAG group.

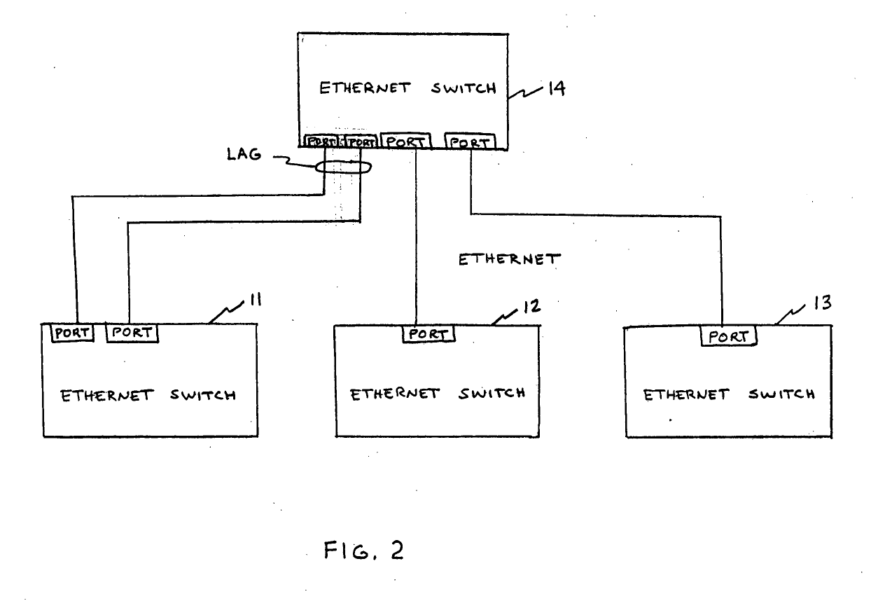

FIG. 3 shows two redundant switches connected to another switch.

FIG. 4 shows two redundant switches connected to another switch including a LAG.

FIG. 5 shows two redundant switches, one including a LAG group and the other in a port forwarding state, connected to another switch including another LAG group according to an exemplary embodiment of the present invention.

FIG. 6 shows the resiliency of the system shown in FIG. 5, according to an exemplary embodiment of the present invention.

FIG. 7 is a flow diagram of part of a method performed in accordance with an exemplary embodiment of the present invention.

Identically labeled elements appearing in different ones of the figures refer to the same elements but may not be referenced in the description for all figures.

### DETAILED DESCRIPTION OF THE INVENTION

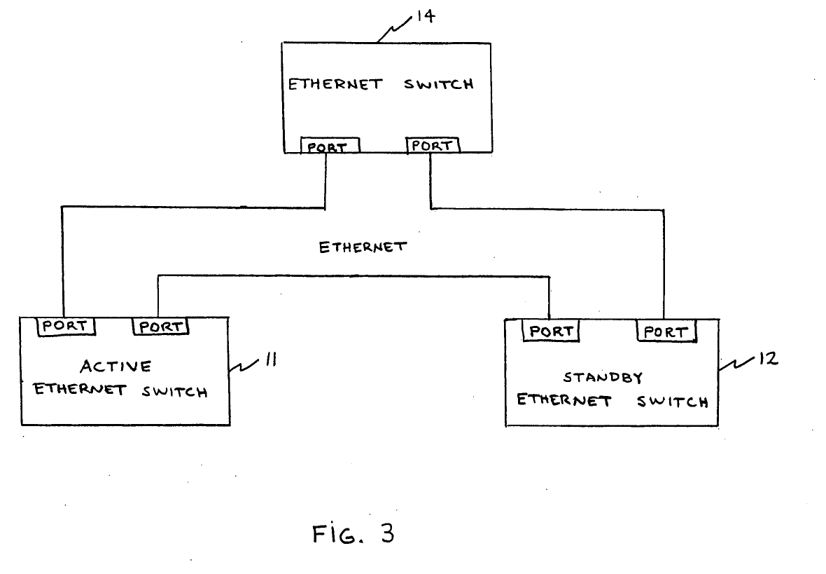

FIG. 3 shows two separate redundant switches 1 and 12 connected to another switch 14. In the exemplary embodiment described herein, the redundant switches 11 and 12 can be, for example, switches of uplink cards in a network infrastructure such as the Tellabs® 1020 multi-service access system, and the other switch 14 can be, for example, an Ethernet switch or another suitable type of switch.

Switches, as described above and as they relate to computer networking and Ethernet, can be hardware-based devices which control the flow of data packets based upon destination address information available in each packet. Switches can be capable of receiving a packet and switching the packet to an appropriate output port at what is referred to wirespeed or linespeed, which is the maximum speed capability of the particular network.

Although not shown for convenience, each switch 11, 12, and 14 can be connected to other network components as well for communicating therewith.

As shown in FIG. 3, switch 11 is in the active mode and, as such, should be the only device able to forward traffic from its internal data forwarding plane while in that mode. Switch 12, on the other hand, is shown to be operating in the standby mode. Each switch is selectively operable in each such mode.

In the configuration shown in FIG. 3, if switch 11 should fail, there is no immediate mechanism for switch 14 to start communicating with switch 12 because switches 11 and 12 are connected to separate ports of switch 14 (even when switch 12 is enabled and has switched from a standby mode to an active mode).

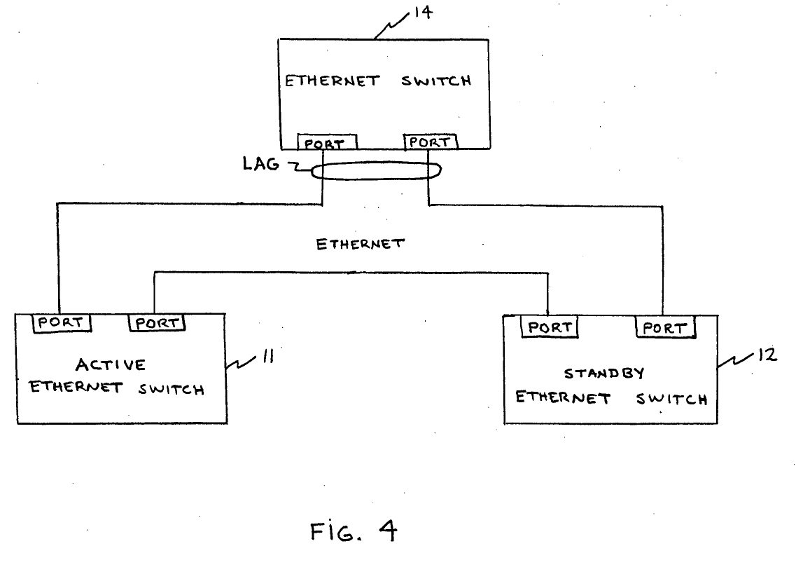

To solve this problem, the ports of switch 14 can be configured to be in a LAG, as shown in FIG. 4. As such, the ports of switch 14 appear, logically, as a single port connected to switches 11 and 12 making communications with switch 12 possible should switch 11 fail. The LAG of the ports of switch 14 can be configured by a user manually using a user interface or automatically by a control management CPU (not shown in FIG. 4).

By virtue of the configuration of FIG. 4, switch 11 is connected by a single port to switch 14, and switch 12 is also connected by a single port to switch 14. As such, communications with switches 11 or 12 are possible but at a bandwidth limited to that of a single port.

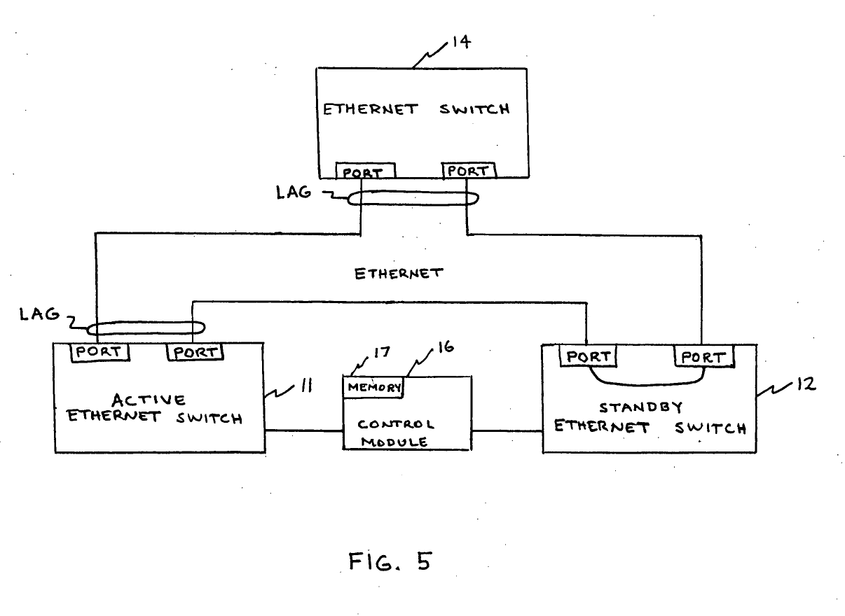

To increase the bandwidth capacity of the configuration of FIG. 4, and to take advantage of the ports of switch 14 being in a LAG, according to an exemplary embodiment of the invention, shown in FIG. 5, switch 11 ports are configured in a LAG and a port forwarding rule is applied in switch 12. The LAG at switch 11 can be configured in the manner described above. The port forwarding rule can direct switch 12 to forward data packets between its ports. As such, the link between switch 11 and switch 12 can be effectively a direct connection from switch 11 to switch 14, as shown in FIG. 5. This can be accomplished by coupling the ports of switch 12 together, either automatically by internal operation of the switch or manually.

As illustrated in FIG. 5, when switch 11 is configured with both ports in a LAG, and switch 12 is configured with a port forwarding rule, switch 11 is effectively seen at switch 14 as a single LAG resulting in the bandwidth being doubled. This is because, by virtue of the configuration of FIG. 5, switch 11 has effectively two ports connected to the two ports of switch 14.

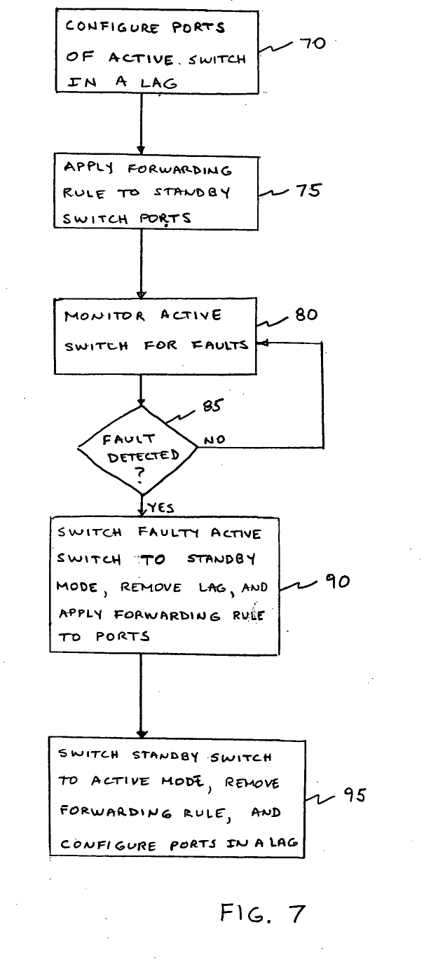

A control module 16 can manage switches 11 and 12 in accordance with software control programs and operating routines stored in an associated memory 17. The control module 16 at least monitors switches 11 and 12 for faults, such as port failures and degraded performance and the like using known monitoring techniques, controls the LAGs and application of port forwarding rules, and the operating modes, such as active or standby, of switches 11 and 12. At least some of those programs and routines implement at least part of a method of the invention to be described below in conjunction with FIG. 7.

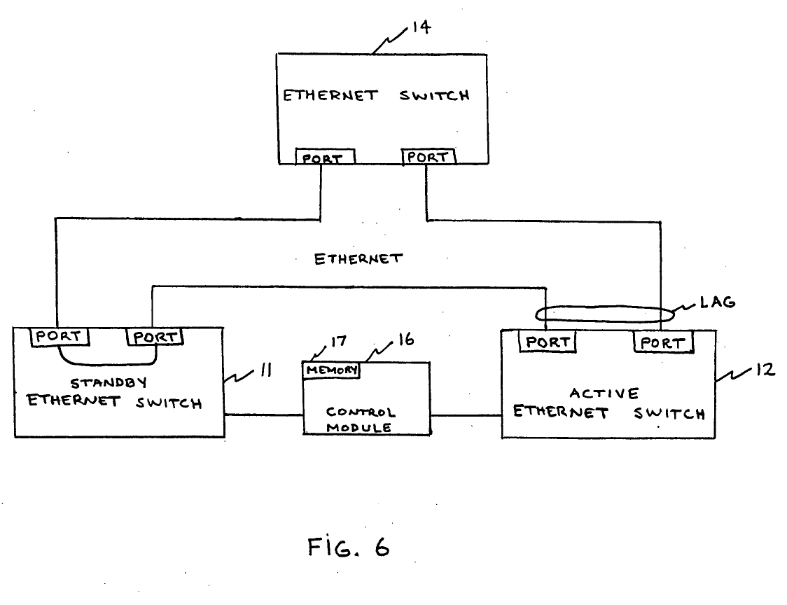

The resiliency of the configuration of FIG. 5 will now be described with reference to FIG. 6.

When switch 11 fails, as detected by module 16, switch 11 is placed in a standby mode and configured with the port forwarding rule and the LAG removed, and switch 12 is placed by module 16 in an active mode with its ports configured to be in a LAG and the port forwarding rule removed, as shown in FIG. 6. By virtue of the configuration of FIG. 6, the resiliency of the system can be maintained when switch 11 fails.

Further, resiliency can be maintained in a case in which the connection from switch 14 to switch 11 fails. For example, in the configuration of FIG. 5, all traffic handled by that failed connection would be switched to the LAG port that connects switch 11 to switch 12 and the port forwarding rule of switch 12 would forward the traffic up to switch 14. The bandwidth would be exactly half of the LAG bandwidth or exactly the bandwidth of one link because, effectively, only one link remains.

Furthermore, resiliency can be maintained in a case in which the link from active switch 11 to standby switch 12 fails. For example, in the configuration of FIG. 5, all traffic from switch 11 would flow directly to switch 14. Again, the bandwidth would be exactly half of the LAG bandwidth or exactly the bandwidth of one link because, effectively, only one link remains.

FIG. 7 is a flow diagram of part of the method of this invention and may be implemented by the control module 16 shown in FIGS. 5 and 6, according to an exemplary embodiment of the invention. The ports of the active switch are configured in a LAG at step 70, and a forwarding rule is applied to the standby switch ports at step 75. In other embodiments, the rule may be a port mirroring rule where, in addition to forwarding the packets between ports, a copy of the packets is sent a monitoring network connection (not shown).

The active switch is monitored for faults at step 80 and, when a fault is detected at step 85, the faulty active switch is switched to standby mode, the LAG is removed, and a forwarding rule is applied to the ports at step 90. Then, at step 95, the standby switch is switched to active mode, the forwarding rule is removed, and the ports are configured in a LAG.

By virtue of the foregoing, improved methods, systems, apparatus, and programs to link aggregate over independent redundant switches using forwarding rules are provided resulting in a network with optimized bandwidth and resiliency.

In the foregoing description, the invention is described with reference to a specific example embodiment thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of the present invention may be provided as a computer program product, or software, that may include an article of manufacture on a machine accessible or machine readable medium (memory) having instructions (see, e.g., FIG. 7). The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While the invention has been particularly shown and described with respect to a preferred embodiment thereof, it should be understood that the embodiment has been presented by way of example, and not limitation. It will be apparent to persons skilled in the relevant art(s) that various changes in form and detail can be made therein without departing from the spirit and scope of the present invention. Thus, the present invention should not be limited by any above-described exemplary embodiment, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for use in an apparatus including first, second, and third switches in a local area network (LAN), wherein a first port of the first switch is connected to a first port of the second switch, a second port of the second switch is connected to a first port of the third switch, and a second port of the third switch is connected to a second port of the first switch, the method comprising:
forming a first link aggregation group (LAG) between the first and second ports of the first switch;
forming a second LAG between the first and second ports of the second switch; and
applying a port forwarding rule to the first and second ports of the second switch, wherein the first switch is in an active mode and the second switch is in a standby mode.

2. The method according to claim 1, wherein the LAN is an Ethernet.

3. The method according to claim 2, wherein the second and third switches are redundant switches.

4. The method according to claim 3, wherein the first switch is an Ethernet switch.
